(19) United States
(12) Patent Application Publication
(10) Pub. No.: US 2022/0247901 A1
(43) Pub. Date: Aug. 4, 2022

(54) SET OF OPTICAL FILM FOR IMAGE GENERATION SYSTEM

(71) Applicant: NITTO DENKO CORPORATION, Ibaraki-shi, Osaka (JP)

(72) Inventors: Yoshiaki Asanoi, Ibaraki-shi (JP); Akinori Izaki, Ibaraki-shi (JP)

(73) Assignee: NITTO DENKO CORPORATION, Ibaraki-shi, Osaka (JP)

(21) Appl. No.: 17/620,304

(22) PCT Filed: May 27, 2020
(86) PCT No.: PCT/JP2020/020913

§ 371 Date: Dec. 17, 2021

(30) Foreign Application Priority Data
Jun. 20, 2019 (JP) 2019-114487

(51) Int. Cl. H04N 5/225; G02B 5/30; H04N 5/232

(52) U.S. Cl. CPC H04N 5/2254; H04N 5/23219; G02B 5/3041

(57) ABSTRACT

According to an embodiment of the present invention, there is provided an optical film set for an image generation system. The set includes a first polarizing plate; a second polarizing plate; a first retardation plate; and a second retardation plate. The image generation system includes an image taking apparatus, the first polarizing plate, the first retardation plate, an object, the second retardation plate, and the second polarizing plate arranged in the stated order.

### TECHNICAL FIELD

The present invention relates to an optical film set for an image generation system.

### BACKGROUND ART

An image synthesis technology has been widely used in a video field, such as television broadcasting or a movie. Image synthesis is typically performed by the following procedure: an image of an object, such as a person, which is a foreground (hereinafter simply referred to as “object”) is taken with a camera or the like against the background of a backscreen made of cloth having, for example, a blue color or green color that is a complementary color to a skin color; and a chroma key apparatus is used to detect a signal of the taken image corresponding to, for example, the blue color and extract an object image region, to transparentize information about a background image as a key signal, and to subject the object image and another background image to image synthesis.

The conventional image synthesis technology involves the following problems. (i) An extremely precise lighting technique is needed to uniformize, for example, the blue color of the backscreen. (ii) The peripheral edge portion of the object is colored to the color of the backscreen (e.g., a blue color or a green color) under the influence of the reflection of illumination light. (iii) Light cannot be applied from the rear of the backscreen, and hence the image quality of a synthesized image may be insufficient. As a result, to lengthen a distance between the object and the backscreen, a large backscreen is needed (therefore, a large studio is needed), the number of lighting apparatus increases and many kinds of lighting apparatus are needed, and there arises a need to rely on, for example, the ability and know-how of a lighting technician. (iv) The color of the backscreen needs to be changed in accordance with the color of the object, and hence there arises a need to prepare backscreens of many colors and to replace the backscreen in accordance with the object.

To solve such problems as described above, investigations have been made on an image generation method and an image synthesis method each including using an optical monochromatization technology based on a polarizing plate and a retardation plate. Such technology is at the initial stage of development, and hence has room for various investigations.

### CITATION LIST

### Patent Literature

[PTL 1] JP 2002-232909 A

[PTL 2] JP 2015-530004 A

### SUMMARY OF INVENTION

### Technical Problem

The present invention has been made to solve the conventional problems, and an object of the present invention is to provide an optical film set that may be used in an image generation system that: eliminates needs for a large studio, a large number, or many kinds, of lighting fixtures, and the know-how of a lighting technician; suppresses undesired coloring of an object; can easily deal even with a change in color of the object; and enables the utilization of light from the rear, and as a result, can achieve an entire image having excellent image quality.

### Solution to Problem

According to an embodiment of the present invention, there is provided an optical film set for an image generation system. The set includes a first polarizing plate; a second polarizing plate; a first retardation plate; and a second retardation plate. The image generation system includes an image taking apparatus, the first polarizing plate, the first retardation plate, an object, the second retardation plate, and the second polarizing plate arranged in the stated order.

In one embodiment of the present invention, the first retardation plate has an Re(590) of 500 nm or more, and the second retardation plate has an Re(590) of from 50 nm to 300 nm.

In one embodiment of the present invention, the first retardation plate and the second retardation plate are arranged in the image generation system so that slow axes thereof are substantially perpendicular or parallel to each other.

In one embodiment of the present invention, the first polarizing plate and the second polarizing plate are arranged in the image generation system so that absorption axes of polarizers thereof are substantially perpendicular or parallel to each other.

In one embodiment of the present invention, the first retardation plate, the second retardation plate, the first polarizing plate, and the second polarizing plate are arranged in the image generation system so that: an angle formed by a slow axis of the first retardation plate, and an absorption axis of a polarizer of the first polarizing plate and an absorption axis of a polarizer of the second polarizing plate; or an angle formed by a slow axis of the first retardation plate, and an absorption axis of a polarizer of the first polarizing plate or an absorption axis of a polarizer of the second polarizing plate is from 40° to 50° or from 130° to 140°, and are arranged therein so that: an angle formed by a slow axis of the second retardation plate, and the absorption axis of the polarizer of the first polarizing plate and the absorption axis of the polarizer of the second polarizing plate; or an angle formed by a slow axis of the second retardation plate, and the absorption axis of the polarizer of the first polarizing plate or the absorption axis of the polarizer of the second polarizing plate is from 40° to 50° or from 130° to 140°.

In one embodiment of the present invention, the image generation system further includes a lighting apparatus arranged between the first retardation plate and the second retardation plate.

### Advantageous Effects of Invention

According to the embodiments of the present invention, in a so-called chroma key technology, the optical monochromatization technology based on the retardation plate is used instead of a backscreen made of cloth. Accordingly, the image generation system can be achieved, which: eliminates needs for a large studio, a large number, or many kinds, of lighting fixtures, and the know-how of a lighting technician; suppresses undesired coloring of an object; can easily deal even with a change in color of the object; and enables the utilization of light from the rear, and as a result, can achieve an entire image having excellent image quality. Further, the two retardation plates each having a specific configuration are used in combination, and the plates are arranged at specific positions. Accordingly, magenta reflection resulting from illumination light can be significantly suppressed in the entire image (synthesized image) to be obtained.

### BRIEF DESCRIPTION OF DRAWINGS

FIG. 1 is a schematic configuration view for illustrating an example of an image generation system in which an optical film set of the present invention is used.

FIG. 2 is a schematic exploded perspective view for illustrating an example of a method of adjusting an axial angle between the absorption axis of the polarizer of a first polarizing plate and the slow axis of a retardation plate in the image generation system in which the optical film set of the present invention is used.

FIG. 3(a) to FIG. 3(c) are each a schematic view for illustrating an example of image synthesis in the image generation system in which the optical film set of the present invention is used.

### DESCRIPTION OF EMBODIMENTS

The embodiments of the present invention are described below. However, the present invention is not limited to these embodiments.

A. Optical Film Set

An optical film set according to an embodiment of the present invention is used in an image generation system. The optical film set includes a first polarizing plate, a second polarizing plate, a first retardation plate, and a second retardation plate. The image generation system includes an image taking apparatus, the first polarizing plate, the first retardation plate, an object, the second retardation plate, and the second polarizing plate arranged in the stated order. In the embodiment of the present invention, the two retardation plates each having a specific configuration are used in combination, and the plates are arranged at specific positions. Accordingly, magenta reflection resulting from illumination light can be significantly suppressed in an entire image (synthesized image) to be obtained.

Optical films for forming the set and the image generation system using the set are described below. First, the first polarizing plate, the second polarizing plate, the first retardation plate, and the second retardation plate for forming the optical film set are described, and then the image generation system is described. The first polarizing plate and the second polarizing plate are hereinafter collectively described as polarizing plates.

A-1. Polarizing Plates

Any appropriate configuration may be adopted as each of the polarizing plates. The polarizing plates each typically include a polarizer and a protective film arranged on one side, or each of both sides, of the polarizer.

Any appropriate polarizer may be adopted as the polarizer. A resin film for forming the polarizer may be a single-layer resin film, or may be produced by using a laminate of two or more layers.

Specific examples of the polarizer including the single-layer resin film include polyene-based alignment films, such as: a product obtained by subjecting a hydrophilic polymer film, such as a polyvinyl alcohol (PVA)-based resin film, a partially formalized PVA-based resin film, or an ethylene-vinyl acetate copolymer-based partially saponified film, to a dyeing treatment with a dichroic substance, such as iodine or a dichroic dye, and a stretching treatment; a dehydration-treated product of PVA; and a dehydrochlorination-treated product of polyvinyl chloride. A polarizer obtained by dyeing the PVA-based resin film with iodine and uniaxially stretching the resultant is preferably used because of its excellent optical characteristics.

The dyeing with iodine is performed by, for example, immersing the PVA-based resin film in an aqueous solution of iodine. The stretching ratio of the uniaxial stretching is preferably from 3 times to 7 times. The stretching may be performed after the dyeing treatment, or may be performed while the dyeing is performed. In addition, the dyeing may be performed after the stretching. The PVA-based resin film is subjected to, for example, a swelling treatment, a cross-linking treatment, a washing treatment, or a drying treatment as required. For example, when the PVA-based resin film is washed with water by being immersed in the water before the dyeing, contamination and an antiblocking agent on the surface of the PVA-based resin film can be washed off. Moreover, the PVA-based resin film can be swollen to prevent its dyeing unevenness or the like.

The polarizer obtained by using the laminate is specifically, for example, a polarizer obtained by using: a laminate of a resin substrate and a PVA-based resin layer (PVA-based resin film) laminated on the resin substrate; or a laminate of a resin substrate and a PVA-based resin layer applied and formed on the resin substrate. The polarizer obtained by using the laminate of the resin substrate and the PVA-based resin layer applied and formed on the resin substrate may be produced, for example, by: applying a PVA-based resin solution to the resin substrate, followed by its drying to form the PVA-based resin layer on the resin substrate, thereby providing the laminate of the resin substrate and the PVA-based resin layer; and stretching and dyeing the laminate to turn the PVA-based resin layer into the polarizer. In this embodiment, the stretching typically includes stretching the laminate while immersing the laminate in an aqueous solution of boric acid. Further, the stretching may further include subjecting the laminate to in-air stretching at high temperature (e.g., 95° C. or more) before the stretching in the aqueous solution of boric acid as required. The resultant laminate having the configuration “resin substrate/polarizer” may be used as it is (i.e., the resin substrate may be used as a protective layer for the polarizer), or may be used after the resin substrate has been peeled from the laminate having the configuration “resin substrate/polarizer”, and any appropriate protective layer in accordance with a purpose has been laminated on the peeling surface. Details about a method of producing such polarizer are described in, for example, JP 2012-73580 A, the entire description of which is incorporated herein by reference.

The protective film includes any appropriate film that may be used as a protective film for the polarizer. As a material serving as a main component for the film, there are specifically given, for example, cellulose-based resins, such as triacetylcellulose (TAC), and transparent resins, such as polyester-based, polyvinyl alcohol-based, polycarbonate-based, polyamide-based, polyimide-based, polyether sulfone-based, polysulfone-based, polystyrene-based, polynorbornene-based, polyolefin-based, cyclic olefin-based, (meth)acrylic, and acetate-based resins. There are also given, for example, thermosetting resins or UV-curable resins, such as (meth)acrylic, urethane-based, (meth)acrylic urethane-based, epoxy-based, and silicone-based resins. In addition to the foregoing, there are also given, for example, glassy polymers, such as a siloxane-based polymer. In addition, a polymer film described in JP 2001-343529 A (WO 01/37007 A1) may be used. For example, a resin composition containing a thermoplastic resin having a substituted or unsubstituted imide group in a side chain thereof, and a thermoplastic resin having a substituted or unsubstituted phenyl group and a nitrile group in side chains thereof may be used as a material for the film, and the composition is, for example, a resin composition containing an alternating copolymer formed of isobutene and N-methylmaleimide, and an acrylonitrile-styrene copolymer. The polymer film may be, for example, an extrudate of the resin composition. A (meth)acrylic resin or a cyclic olefin-based resin may be preferably used.

A-2. First Retardation Plate

The in-plane retardation Re(590) of the first retardation plate is preferably 500 nm or more, more preferably from 500 nm to 1,500 nm, still more preferably from 1,100 nm to 1,500 nm. The symbol “Re(λ)” as used herein refers to the in-plane retardation of a film measured at 23° C. with light having a wavelength of λ nm. Accordingly, the symbol “Re(590)” refers to the in-plane retardation of the film measured at 23° C. with light having a wavelength of 590 nm. When the thickness of the film is represented by “d” (nm), the Re(λ) is determined from the equation “Re(λ)=(nx−ny)×d.” Herein, the symbol “nx” refers to a refractive index in the direction in which a refractive index in a plane becomes maximum (i.e., a slow axis direction), and the symbol “ny” refers to a refractive index in the direction perpendicular to the slow axis in the plane (i.e., a fast axis direction).

The first retardation plate has an in-plane retardation as described above, and hence has a relationship of nx>ny. The first retardation plate shows any appropriate refractive index ellipsoid as long as the plate has a relationship of nx>ny. The refractive index ellipsoid of the first retardation plate preferably shows a relationship of nx>ny≥nz.

The wavelength dispersion characteristic “Re(450)/Re(550)” of the first retardation plate is preferably 0.9 or more, more preferably from 0.95 to 1.2. When the wavelength dispersion characteristic “Re(450)/Re(550)” of the first retardation plate falls within such ranges, through the combination with the second retardation plate, the magenta reflection resulting from the illumination light can be significantly suppressed in the entire image (synthesized image) to be obtained while the in-plane retardation Re(590) is set within a practical range.

The first retardation plate includes a resin film (typically a stretched film of the resin film) that may satisfy such characteristics as described above. Typical examples of the resin for forming the first retardation plate include a polyester-based resin (e.g., polyethylene terephthalate or polyethylene naphthalate), a polycarbonate-based resin, a polyether-based resin (e.g., polyether ether ketone), a polystyrene-based resin, and a cyclic olefin-based resin. In particular, a polyester-based resin and a polycarbonate-based resin may each be suitably used because each of the resins has a large intrinsic birefringence, and relatively easily provides a large in-plane retardation even when its stretching ratio is low or its thickness is small.

The first retardation plate may be obtained by stretching the resin film. Any appropriate stretching method and stretching conditions (e.g., a stretching temperature, a stretching ratio, and a stretching direction) may be adopted for the stretching in accordance with a desired in-plane retardation (finally, a desired color of the background color).

The first retardation plate may be a single resin film (stretched film), or may be a laminated film obtained by laminating a plurality of resin films (stretched films). The single film has an advantage in that the film is easily produced and is available at low cost. The laminated film has an advantage in that its in-plane retardation is easily adjusted.

The thickness of the first retardation plate (in the case of a laminated film, its total thickness) may be appropriately set in accordance with, for example, a desired in-plane retardation and a constituent material.

A commercial retardation film may be used as the first retardation plate, or a product obtained by subjecting the commercial retardation film to secondary processing (e.g., stretching) or a product obtained through lamination thereof may be used.

A-3. Second Retardation Plate

The in-plane retardation Re(590) of the second retardation plate is preferably from 50 nm to 300 nm, more preferably from 70 nm to 200 nm, still more preferably from 90 nm to 140 nm. When the in-plane retardation of the second retardation plate falls within such ranges, the illumination light reflected by the object passes through the second retardation plate to be reduced in coloring. As a result, the magenta reflection resulting from the illumination light can be significantly suppressed in the entire image (synthesized image) to be obtained. That is, the arrangement of the second retardation plate can reduce the coloring of the reflected light of the illumination light by the object to suppress the magenta reflection. The in-plane retardation of the second retardation plate is substantially independent of the in-plane retardation of the first retardation plate, and only needs to fall within such suitable ranges as described above.

The refractive index ellipsoid, wavelength dispersion characteristic, constituent material, and formation method of the second retardation plate are as described in the section A-2 for the first retardation plate.

B. Image Generation System

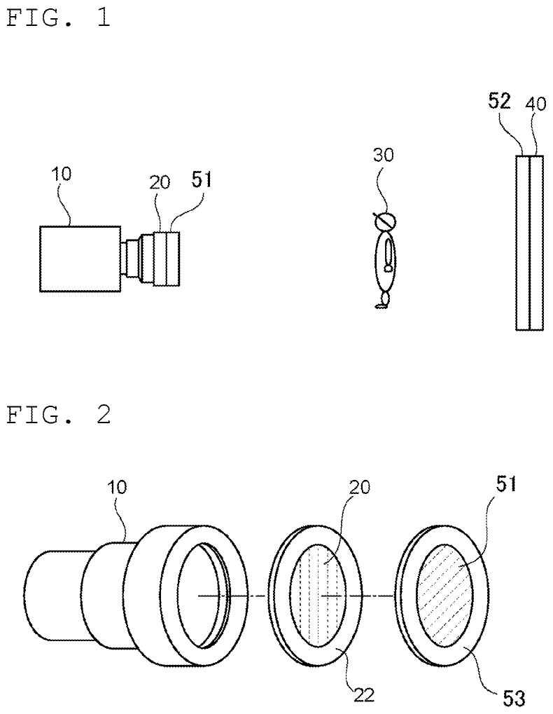

FIG. 1 is a schematic view for illustrating an example of the image generation system in which the optical film set of the present invention is used. For ease of viewing, the sizes of the image taking apparatus, the object, the first polarizing plate, the second polarizing plate, the first retardation plate, and the second retardation plate in each of the figures, and a mutual ratio among these sizes are different from actual ones.

The image generation system includes an image taking apparatus 10, a first polarizing plate 20, a first retardation plate 51, an object 30, a second retardation plate 52, and a second polarizing plate 40 arranged in the stated order. More specifically, the first retardation plate 51 is arranged between the first polarizing plate 20 and the object 30, and the second retardation plate 52 is arranged between the object 30 and the second polarizing plate 40. The image generation system uses the second polarizing plate 40 (substantially its laminate with the second retardation plate 52) instead of a backscreen, and takes an image of the object 30 against the background of the second polarizing plate 40 with the image taking apparatus (typically a camera apparatus) 10.

In the embodiment of the present invention, the color of the second polarizing plate 40 recognized by the image taking apparatus 10 (i.e., displayed and taken by the image taking apparatus) is monochromatized to a color complementary to that of the object 30 by arranging at least one retardation plate. More specifically, the color of the second polarizing plate 40 recognized by the image taking apparatus 10 can be monochromatized to the color complementary to that of the object 30 by optimizing at least one of: the in-plane retardation Re(590) of the at least one retardation plate; an angle between the slow axis of the at least one retardation plate and the absorption axis of the polarizer in the first polarizing plate; an angle between the slow axis of the at least one retardation plate and the absorption axis of the polarizer in the second polarizing plate; or an angle between the absorption axis of the polarizer in the first polarizing plate and the absorption axis of the polarizer in the second polarizing plate. In, for example, the case where the object is a person, the main color of the object is a skin color, and a complementary color thereto is a green color or a blue color, preferably a green color. In this case, the color of the second polarizing plate 40 recognized by the image taking apparatus 10 can be set to a green color or a blue color (preferably a green color) by performing such optimization as described above. As a result, the image taking apparatus can take an image of the object against the background of a green color. Such green background may function similarly to a conventional backscreen (e.g., green cloth) in a chroma key technology, and may exhibit an effect much more excellent than that of the conventional backscreen as described later. Further, in the embodiment of the present invention, the first retardation plate as described in the section A-2 and the second retardation plate as described in the section A-3 are used in combination, the first retardation plate is arranged between the first polarizing plate and the object, and the second retardation plate is arranged between the object and the second polarizing plate. Accordingly, the magenta reflection resulting from the illumination light can be significantly suppressed in the entire image (synthesized image) to be obtained.

Now, the advantage of the monochromatization of the color of the second polarizing plate recognized by the image taking apparatus as described above is described. The second polarizing plate is optically colored, and hence its color is monochromatized to a desired color in an extremely uniform manner over the entirety of the taken image (displayed image) of the image taking apparatus excluding the object. As a result, uniformity at the time of the transparentization of the color in the chroma key technology is extremely excellent, and hence the image quality of the background in a synthesized image to be obtained is also excellent. Further, such optical monochromatization has the following advantages over a case in which a backscreen made of cloth is used. (1) When the backscreen (e.g., green cloth) is used, illumination light for uniformizing the color of the backscreen is reflected, and the reflected light is reflected in the object to color the peripheral edge portion of the object to the color of the backscreen (e.g., a green color). In contrast, the optical coloring in the embodiment of the present invention eliminates the need for lighting for uniformizing a background color, and hence can substantially completely prevent undesired coloring of the peripheral edge portion of the object. (2) As described above, the lighting for uniformizing the color of the backscreen is not needed, and hence there is no need to arrange a large number, or many kinds, of lighting fixtures. As a result, a large studio where a lighting fixture and a backscreen can be arranged is not needed, thereby leading to an advantage in terms of cost. In addition, an image can be taken in a small studio (substantially only the arrangement of the second polarizing plate needs to be secured), and hence the number of options of the image taking markedly increases. In addition, there is no need to rely on, for example, the ability and know-how of a skilled lighting technician, and hence fluctuation in image quality resulting from image taking circumstances (e.g., the presence or absence of the securement of human resources) can be prevented. (3) The backscreen shields light from the rear. Accordingly, for example, when the object is synthesized with a background image that the light has entered from the rear, such light does not impinge on the object, and as a result, a feeling of wrongness occurs in the synthesized image. In contrast, according to the embodiment of the present invention, the light from the rear can be utilized. As a result, when the object is synthesized with such background image that the light has entered from the rear as described above, a synthesized image having no feeling of wrongness can be obtained. Further, the image quality of the synthesized image can be adjusted in accordance with a purpose by utilizing the light from the rear. As a result, there is no need to lengthen a distance between the object and the backscreen, and hence a large backscreen is not needed. Thus, the same effect as the (2) is obtained. Accordingly, according to the embodiment of the present invention, an entire image (synthesized image) having excellent image quality can be achieved simply and easily, and at low cost.

Further, according to such optical monochromatization as described above, it becomes extremely easy to uniformly display (finally, take), on the image taking apparatus, an image of the background in accordance with the color of the object in a color complementary thereto. This is because when, for example, the in-plane retardation Re(590) of the at least one retardation plate, and an axial angle between the at least one retardation plate, and the first polarizing plate and/or the second polarizing plate are adjusted, a desired color can be optically achieved in the image taking apparatus (substantially the displayed image or taken image of the image taking apparatus) without any need for a large studio, and a large-scale apparatus or material. As a result, there is no need to prepare backscreens of many colors, and there is also no need to replace such many backscreens in accordance with the object.

In one embodiment, the first polarizing plate 20 and the second polarizing plate 40 are arranged so that the absorption axis of the polarizer of the first polarizing plate and the absorption axis of the polarizer of the second polarizing plate are preferably substantially perpendicular or substantially parallel to each other. The expression “substantially perpendicular” as used herein includes a case in which an angle formed by two directions is 90°±7°, and the angle is preferably 90°±5°, more preferably 90°±3°. The expression “substantially parallel” includes a case in which an angle formed by two directions is 0°±7°, and the angle is preferably 0°±5°, more preferably 0°±3°. Further, the simple term “perpendicular” or “parallel” as used herein may include a substantially perpendicular or substantially parallel state. In addition, when reference is made to an angle in this description, the reference includes angles in both of a clockwise direction and a counterclockwise direction with respect to a reference direction.

In one embodiment, the second polarizing plate 40 may be arranged so that its absorption axis is in a vertical direction (its transmission axis is in a horizontal direction). With such configuration, the coloring of the object can be significantly suppressed. In this case, the first polarizing plate 20 may be typically arranged so that its absorption axis is in the horizontal direction (its transmission axis is in the vertical direction).

In one embodiment, the first retardation plate 51 and the second retardation plate 52 are arranged so that their slow axes are preferably substantially perpendicular, or substantially parallel, to each other.

In one embodiment, the first retardation plate 51 is arranged so that an angle formed by the slow axis of the first retardation plate and the absorption axis of the polarizer of the first polarizing plate 20 and/or the absorption axis of the polarizer of the second polarizing plate 40 is preferably from 40° to 50° or from 130° to 140°. Similarly, the second retardation plate 52 is arranged so that the angle formed by the slow axis of the second retardation plate and the absorption axis of the polarizer of the first polarizing plate 20 and/or the absorption axis of the polarizer of the second polarizing plate 40 is preferably from 40° to 50° or from 130° to 140°. The angle is more preferably from 42° to 48° or from 132° to 138°, still more preferably from 43° to 47° or from 133° to 137°, still further more preferably about 45° or about 135°.

The in-plane retardations Re(590) and wavelength dispersion characteristics of the first retardation plate 51 and the second retardation plate 52 are as described in the section A-2 and the section A-3, respectively. When the in-plane retardation and wavelength dispersion characteristic of the first retardation plate are appropriately adjusted as described above in combination with the adjustment of the axial angle between each of the first and second polarizing plates, and the first retardation plate described above, the color (background color) of the second polarizing plate in the image taking apparatus can be set to a desired color. In particular, a dark green color can be achieved. Further, the arrangement of the second retardation plate at a predetermined position can significantly suppress the magenta reflection resulting from the illumination light in the entire image (synthesized image) to be obtained.

Some examples of a relationship between each of the angle between the absorption axis of the polarizer of the first polarizing plate and the absorption axis of the polarizer of the second polarizing plate (hereinafter sometimes referred to as “absorption axis angle”), the angle between the slow axis of the first retardation plate and the absorption axis of the polarizer of the first polarizing plate (hereinafter sometimes referred to as “slow axis angle”), and the in-plane retardation Re(590) of the first retardation plate, and the color (background color) of the second polarizing plate in the image taking apparatus are described as follows: (a) when the absorption axis angle is perpendicular or parallel, the slow axis angle is 45° or 135°, and the in-plane retardation Re(590) is from 600 nm to 900 nm, the background color is turned into a dark green color by setting the wavelength dispersion characteristic “Re(450)/Re(550)” to from 1.0 to 1.2; (b) when the absorption axis angle is perpendicular or parallel, the slow axis angle is 45° or 135°, and the in-plane retardation Re(590) is from 1,150 nm to 1,450 nm, the background color is turned into a dark green color by setting the wavelength dispersion characteristic “Re(450)/Re(550)” to from 0.95 to 1.15; and (c) when the absorption axis angle is perpendicular or parallel, the slow axis angle is 45° or 135°, and the in-plane retardation Re(590) is from 1,700 nm to 2,000 nm, the background color is turned into a dark green color by setting the wavelength dispersion characteristic “Re(450)/Re(550)” to from 0.9 to 1.1. A background color except a green color can be achieved by appropriately setting the combination. Specific examples thereof are described as follows: (d) when the absorption axis angle is perpendicular, the slow axis angle is 45°, and the in-plane retardation Re(590) is from 500 nm to 600 nm, the background color is a blue color; (e) when the absorption axis angle is parallel, the slow axis angle is 45°, and the in-plane retardation Re(590) is from 500 nm to 600 nm, the background color is an orange color; (f) when the absorption axis angle is perpendicular, the slow axis angle is 45°, and the in-plane retardation Re(590) is from 400 nm to 500 nm, the background color is a yellow color; (g) when the absorption axis angle is perpendicular, the slow axis angle is 45°, and the in-plane retardation Re(590) is from 200 nm to 400 nm, the background color is a purple color; (h) when the absorption axis angle is parallel, the slow axis angle is 45, and the in-plane retardation Re(590) is from 400 nm to 500 nm, the background color is a dark blue color; and (i) when the absorption axis angle is perpendicular, the slow axis angle is 45°, and the in-plane retardation Re(590) is from 1,500 nm to 1,600 nm, the background color is a magenta color. When the absorption axis angle, the slow axis angle, and the in-plane retardation Re(590) of the first retardation plate are appropriately adjusted in combination as described above, the background color can be set to a desired color. Moreover, a complicated apparatus and a large-scale facility are not needed in such adjustment of the absorption axis angle, the slow axis angle, and the in-plane retardation Re(590), and hence a desired background color can be obtained in accordance with, for example, the object, a desired synthesized image, and the circumstances of a shooting site. Further, the adjustment of the in-plane retardation Re(590) of the first and/or second retardation plate enables the fine adjustment of the background color. In any case, the arrangement of the second retardation plate at a predetermined position can significantly suppress the magenta reflection resulting from the illumination light in the entire image (synthesized image) to be obtained.

The adjustment of the absorption axis angle and the slow axis angle is described. FIG. 2 is a schematic exploded perspective view for illustrating an example of a method of adjusting the absorption axis angle and the slow axis angle. As illustrated in FIG. 2, the first polarizing plate 20 is rotatably mounted to the image taking apparatus (the tip portion of the lens of a camera apparatus in the illustrated example) through a holder 22. Further, the first retardation plate 51 is mounted to the holder 22 of the first polarizing plate through a holder 53 in a relatively rotatable manner. The rotation of the holder 22 can set the direction of the absorption axis of the first polarizing plate. Moreover, such adjustment of the absorption axis direction by the rotation of the holder 22 can be performed in an extremely small angle unit (e.g., 1°), and hence enables the fine adjustment of the background color. Similarly, the rotation of the holder 53 relative to the holder 22 can set the slow axis angle. The setting of the slow axis angle can also be performed in an extremely small angle unit (e.g., 1°), and hence enables the fine adjustment of the background color. The setting of the slow axis angle may be performed by rotating the holder 53, may be performed by rotating the holder 22, or may be performed by rotating both the holders. The setting of the slow axis angle is practically performed by rotating the holder 53 while fixing the holder 22 (fixing the direction of the absorption axis of the first polarizing plate). With such system as described above, the absorption axis direction of the polarizer of the first polarizing plate and the slow axis direction of the first retardation plate can each be adjusted in an extremely small angle unit by fixing the absorption axis direction of the polarizer of the second polarizing plate in a predetermined direction.

An antiglare layer and/or an antireflection layer may be arranged on the surface of the second polarizing plate 40 (substantially the surface of the second retardation plate 52 laminated on the second polarizing plate) as required. The arrangement of the antiglare layer and/or the antireflection layer can provide a more satisfactory background color because the arrangement can further suppress the reflection and glare of the second polarizing plate, and the reflection of ambient light in the second polarizing plate. Detailed description of the antiglare layer and the antireflection layer is omitted because a configuration well-known in the art may be adopted.

As described above, according to the embodiment of the present invention, light from the rear can be utilized. Accordingly, in one embodiment, a lighting apparatus (not shown) may be arranged behind the second polarizing plate 40. The lighting angle of the rear lighting apparatus is preferably 38° or more, more preferably 41° or more with respect to a straight line, which connects the image taking apparatus 10 and the object 30 when viewed from above, in a horizontal surface including the straight line. The upper limit of the lighting angle is, for example, 75°. When the lighting angle falls within such ranges, the coloring of the object can be significantly suppressed.

In one embodiment, a lighting apparatus (not shown) may be arranged between the first retardation plate 51 and the second retardation plate 52. In this case, the lighting apparatus may be preferably arranged above the object 30. The effects of the present invention are significant in such case. That is, according to the present invention, magenta reflection resulting from illumination light from above can be significantly suppressed in the entire image (synthesized image) to be obtained. The lighting apparatus may be arranged substantially directly above the object, may be arranged above the front (image taking apparatus side) of the object, or may be arranged above the rear (second polarizing plate side) of the object.

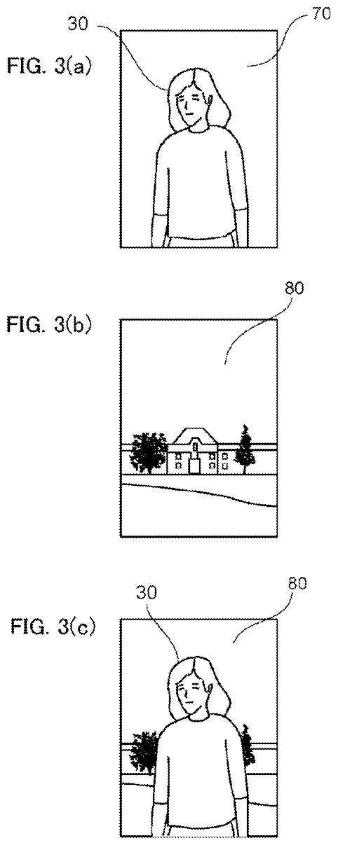

In the image generation system in which the optical film set of the present invention is used, the background image portion of the image generated as described above, which includes the object and the monochromatized background portion, is synthesized with another image. FIG. 3(a) to FIG. 3(c) are each a schematic view for illustrating an example of the image synthesis. First, as described above, as illustrated in FIG. 3(a), an image including the object 30 and a monochromatized background portion 70 is generated. As described above, the background portion 70 is obtained by optically coloring the second polarizing plate 40 in the displayed image (taken image) of the image taking apparatus. Information about the color of the background portion is transparentized as a key signal by using a predetermined video synthesis technology. Meanwhile, as illustrated in FIG. 3(b), another image 80 serving as the final background image is prepared. When information about the other image 80 is introduced into the transparentized background portion 70, as illustrated in FIG. 3(c), a synthesized image including the object 30 and the other image (final background image) 80 may be obtained.

### EXAMPLES

The present invention is specifically described below by way of Examples. However, the present invention is not limited by these Examples.

### Example 1

A polarizing plate (first polarizing plate) and a retardation plate (first retardation plate) were sequentially mounted to the tip portion of the lens of a camera for television shooting from the lens side. A commercial polarizing plate (product obtained by removing a pressure-sensitive adhesive from a product available under the product name “SEG1425GU” from Nitto Denko Corporation) was used as the first polarizing plate. A product obtained by laminating five commercial cycloolefin resin retardation films (manufactured by Kaneka Corporation, product name: “UTZ-FILM #270,” in-plane retardation Re(590)=270 nm) and one commercial cycloolefin resin retardation film (manufactured by Kaneka Corporation, product name: “UTZ-FILM #110,” in-plane retardation Re(590)=110 nm) so that their slow axes were parallel to each other was used as the first retardation plate. The first retardation plate (laminate) had an in-plane retardation Re(590) of 1,460 nm. The direction of the absorption axis of the polarizer of the first polarizing plate was set in a vertical direction, and the direction of the slow axis of the first retardation plate was set in a direction at 45° counterclockwise with respect to the vertical direction when viewed from the first retardation plate side. Hereinafter, in Examples and Comparative Examples, the vertical direction is defined as 90°, a horizontal direction is defined as 0°, and a counterclockwise direction with respect to the vertical direction when viewed from the first retardation plate side is defined as a “plus (+) direction” (e.g., 135° corresponds to 45° counterclockwise with respect to the vertical direction when viewed from the first retardation plate side). Next, a commercial polarizing plate (second polarizing plate) was arranged at a predetermined position. At this time, the absorption axis of the polarizer of the second polarizing plate was set to 0°. Further, a second retardation plate was arranged on the object side of the second polarizing plate. A commercial cycloolefin resin retardation film (manufactured by Kaneka Corporation, product name: “UTZ-FILM #110,” in-plane retardation Re(590)=110 nm) was used as the second retardation plate. The second retardation plate was arranged so that its slow axis was perpendicular to the slow axis of the first retardation plate. An image of an object (person) was taken with a camera for television shooting having mounted thereto the first polarizing plate and the first retardation plate described above against the background of the second polarizing plate (substantially its laminate with the second retardation plate). At the time of the image taking, the object was illuminated from substantially directly above the object. The background (second polarizing plate) in the taken image had a uniform green color.

Next, information about the color of the background portion of the taken image was transparentized as a key signal by using an ordinary method. Further, information about another image (scene image) was introduced into the transparentized portion. Thus, a synthesized image was obtained. In the synthesized image, no magenta reflection resulting from illumination light was observed.

### Comparative Example 1

A taken image and a synthesized image were obtained in the same manner as in Example 1 except that the second retardation plate was not used. The background (second polarizing plate) in the taken image had a uniform green color. In the synthesized image, magenta reflection resulting from illumination light was observed.

### INDUSTRIAL APPLICABILITY

The optical film set according to the embodiment of the present invention is used in an image generation system. The image generation system may be suitably used in a video field, such as television broadcasting or a movie.

### REFERENCE SIGNS LIST

10 image taking apparatus
20 first polarizing plate
30 object
40 second polarizing plate
51 first retardation plate
52 second retardation plate

1. An optical film set for an image generation system, comprising:
a first polarizing plate;
a second polarizing plate;
a first retardation plate; and
a second retardation plate,
wherein the image generation system includes an image taking apparatus, the first polarizing plate, the first retardation plate, an object, the second retardation plate, and the second polarizing plate arranged in the stated order.

2. The optical film set for an image generation system according to claim 1, wherein the first retardation plate has an Re(590) of 500 nm or more, and the second retardation plate has an Re(590) of from 50 nm to 300 nm.

3. The optical film set for an image generation system according to claim 1, wherein the first retardation plate and the second retardation plate are arranged in the image generation system so that slow axes thereof are substantially perpendicular or parallel to each other.

4. The optical film set for an image generation system according to claim 1, wherein the first polarizing plate and the second polarizing plate are arranged in the image generation system so that absorption axes of polarizers thereof are substantially perpendicular or parallel to each other.

5. The optical film set for an image generation system according to claim 1, wherein the first retardation plate, the second retardation plate, the first polarizing plate, and the second polarizing plate are arranged in the image generation system so that: an angle formed by a slow axis of the first retardation plate, and an absorption axis of a polarizer of the first polarizing plate and an absorption axis of a polarizer of the second polarizing plate; or an angle formed by a slow axis of the first retardation plate, and an absorption axis of a polarizer of the first polarizing plate or an absorption axis of a polarizer of the second polarizing plate is from 40° to 50° or from 130° to 140°, and are arranged therein so that: an angle formed by a slow axis of the second retardation plate, and the absorption axis of the polarizer of the first polarizing plate and the absorption axis of the polarizer of the second polarizing plate; or an angle formed by a slow axis of the second retardation plate, and the absorption axis of the polarizer of the first polarizing plate or the absorption axis of the polarizer of the second polarizing plate is from 40° to 50° or from 130° to 140°.

6. The optical film set for an image generation system according to claim 1, wherein the image generation system further includes a lighting apparatus arranged between the first retardation plate and the second retardation plate.

7. An image generation system, comprising the followings in the stated order:
an image taking apparatus;
a first polarizing plate;
a first retardation plate;
an object;
a second retardation plate; and
a second polarizing plate.

8. The image generation system according to claim 7, wherein the first retardation plate has an Re(590) of 500 nm or more, and the second retardation plate has an Re(590) of from 50 nm to 300 nm.

9. The image generation system according to claim 7, wherein the first retardation plate and the second retardation plate are arranged so that slow axes thereof are substantially perpendicular or parallel to each other.

10. The image generation system according to claim 7, wherein the first polarizing plate and the second polarizing plate are arranged so that absorption axes of polarizers thereof are substantially perpendicular or parallel to each other.

11. The image generation system according to claim 7, wherein the first retardation plate, the second retardation plate, the first polarizing plate, and the second polarizing plate are arranged so that: an angle formed by a slow axis of the first retardation plate, and an absorption axis of a polarizer of the first polarizing plate and an absorption axis of a polarizer of the second polarizing plate; or an angle formed by a slow axis of the first retardation plate, and an absorption axis of a polarizer of the first polarizing plate or an absorption axis of a polarizer of the second polarizing plate is from 40° to 50° or from 130° to 140°, and are arranged so that: an angle formed by a slow axis of the second retardation plate, and the absorption axis of the polarizer of the first polarizing plate and the absorption axis of the polarizer of the second polarizing plate; or an angle formed by a slow axis of the second retardation plate, and the absorption axis of the polarizer of the first polarizing plate or the absorption axis of the polarizer of the second polarizing plate is from 40° to 50° or from 130° to 140°.

12. The image generation system according to claim 7, further comprising a lighting apparatus arranged between the first retardation plate and the second retardation plate.

13. An image generation system, comprising the followings in the stated order: an image taking apparatus: a first polarizing plate; a first retardation plate; an object; a second retardation plate; and a second polarizing plate,
wherein the first polarizing plate is arranged so that an absorption axis of a polarizer thereof is in a vertical direction, and the second polarizing plate is arranged so that an absorption axis of a polarizer thereof is in a horizontal direction,
wherein the first retardation plate and the second retardation plate are arranged so that slow axes thereof are substantially perpendicular or parallel to each other, and are arranged so that an angle formed by the slow axis of the first retardation plate, and the absorption axis of the polarizer of the first polarizing plate and the absorption axis of the polarizer of the second polarizing plate; or an angle formed by the slow axis of the second retardation plate, and the absorption axis of the polarizer of the first polarizing plate and the absorption axis of the polarizer of the second polarizing plate is from 40° to 50° or from 130° to 140°, and
wherein the first retardation plate has an Re(590) of 500 nm or more, and the second retardation plate has an Re(590) of from 50 nm to 300 nm.

14. The image generation system according to claim 13, further comprising a lighting apparatus arranged above the object.
